(19) United States
(12) Patent Application Publication
(10) Pub. No.: US 2005/0249068 A1
(43) Pub. Date: Nov. 10, 2005

(54) Recording apparatus, visible image forming method, recording medium and computer data signal

(76) Inventors: Hiroki Sugahara, Kanagawa (JP); Ichiro Moritomo, Kanagawa (JP); Hirotsugu Sato, Kanagawa (JP); Mitsuyuki Kobayashi, Kanagawa (JP); Yoshihiko Hotta, Shizuoka (JP); Yoshiko Nakata, Chiba (JP); Yukiko Inada, Tokyo (JP)

Correspondence Address: MORRISON & FOERSTER LLP, 1650 TYSONS BOULEVARD, SUITE 300, MCLEAN, VA, 22102, US

(21) Appl. No.: 11/109,954

(22) Filed: Apr. 20, 2005

(30) Foreign Application Priority Data
Apr. 20, 2004 (JP) 2004-124293

(51) Int. Cl. G11B 5/09

(52) U.S. Cl. 369/47.1; 369/53.1; 369/59.1

(57) ABSTRACT

When an optical recording device of a recording apparatus that is for executing optical recording of information on an optical disk records data on an optical disk, it obtains information by which the content of the data optically recorded can be guessed from the data recorded or from data of the recording apparatus. An image representing the obtained information by which the content of the data can be guessed is formed on a thermosensitive medium provided on the optical disk.

### BACKGROUND OF THE INVENTION

1. Field of the Invention

The present invention relates to a recording apparatus, a visible image forming method, a recording medium, and a computer data signal for forming a visible image for allowing a user to visibly recognize the content stored in an optical disk, on the non-recording surface of the optical disk.

2. Description of the Related Art

Techniques for a thermosensitive medium (reversible thermosensitive medium) on which visible images can be thermally formed/erased repeatedly, and an image forming apparatus (rewritable recording apparatus) for forming/erasing visible images on or from the thermosensitive medium are disclosed in Unexamined Japanese Patent Application KOKAI Publication No. H8-318634.

Meanwhile, personal computers, etc. equipped with a DVD drive can record various information on a writable DVD. The users recognize information recorded on DVDs by handwriting file names or the like on the label surface of the DVDs.

However, such a work has been bothersome for the users, and nevertheless the users have found it difficult to recall the content recorded on the DVDs only by the handwritten file names, etc. Therefore, it has been demanded that the personal computers automatically apply information indicative of the recorded content onto the label surface of the DVDs by printing or by other means. For example, it may be conceivable to provide the above-described thermosensitive medium on the label surface of the DVD and form a visible image representing the recorded content on the thermosensitive medium.

However, because the label surface of a DVD has a limited range for formation of a visible image, it has been necessary to form an appropriate visible image by selecting information sufficient for representing the recorded content.

### SUMMARY OF THE INVENTION

An object of the present invention is to provide a recording apparatus, a visible image forming method, a recording medium, and a computer data signal for forming a visible image for allowing a user to visibly recognize the content stored in an optical disk, on the non-recording surface of the optical disk.

To achieve the above object, a recording apparatus according to a first aspect of the present invention comprises:

a recording section which records predetermined information on a recording surface of an optical disk;

a generation section which generates content information representing a content recorded on the optical disk on which the information has been recorded by the recording section; and

a forming section which forms a visible image on a non-recording surface of the optical disk based on the content information generated by the generation section.

According to this invention, the recording section records predetermined information on the recording surface of an optical disk. The generation section generates content information representing the content recorded on the optical disk on which the information has been recorded by the recording section. The forming section forms a visible image on the non-recording surface of the optical disk based on the content information generated by the generation section.

As a result, a visible image that allows the user to visibly recognize the content recorded on the optical disk can be formed on the non-recording surface of the optical disk.

The forming section may form the visible image toward a thermosensitive medium provided on the non-recording -surface of the optical disk.

The forming section may form a new visible image after erasing an already formed visible image, when forming a visible image on a reversible thermosensitive medium provided on the non-recording surface of the optical disk.

The generation section may generate content information which includes at least any item of a volume name, a folder name, a file name, a remaining data capacity, a used data capacity, and a latest recording date.

The generation section may generate content information in which folder names and/or file names are arranged in ascending order or in descending order based on recording date and time.

The generation section may specify a range in the non-recording surface of the optical disk in which a visible image can be formed, and generate content information in which a size of characters is set such that the characters can be contained within the specified range.

The generation section may specify a range in the non-recording surface of the optical disk in which a visible image can be formed, and generate content information in which number of characters is limited such that the characters can be contained within the specified range.

The generation section may select a title based on a kind of a file, and generate content information including the selected title.

The generation section may count numbers of files of respective kinds, and select a title corresponding to the kind of files that exist most.

The generation section may specify a tiered structure of folders and files, and generate content information including an image representing the specified tiered structure.

The generation section may specify a range in the non-recording surface of the optical disk in which a visible image can be formed, and generate an image in which number of tiers to be spread open in the tiered structure is limited to a number containable in the specified range.

The generation section may specify a tiered structure in which folders are arranged in ascending order or in descending order, based on number of subordinate files and/or number of tiers of subordinate folders.

The generation section may generate content information including an image representing a relationship between a used data capacity and a remaining data capacity.

The recording apparatus may further comprise a display section which displays content information generated by the generation section before the forming section forms a visible image.

To achieve the above object, a recording apparatus according to a second aspect of the present invention comprises:

recording means for recording predetermined information on a recording surface of an optical disk;

generating means for generating content information representing a content recorded on the optical disk on which the information has been recorded by the recording means; and

forming means for forming a visible image on a non-recording surface of the optical disk based on the content information generated by the generating means.

According to this invention, the recording means records predetermined information on the recording surface of an optical disk. The generating means generates content information representing the content recorded on the optical disk on which the information has been recorded by the recording means. The forming means forms a visible image on the non-recording surface of the optical disk based on the content information generated by the generating means.

As a result, a visible image that allows the user to visibly recognize the content recorded on the optical disk can be formed on the non-recording surface of the optical disk.

To achieve the above object, a visible image forming method according to a third aspect of the present invention comprises:

a recording step of recording predetermined information on a recording surface of an optical disk;

a generating step of generating content information representing a content recorded on the optical disk on which the information has been recorded in the recording step; and

a forming step of forming a visible image on a non-recording surface of the optical disk based on the content information generated in the generating step.

According to this invention, predetermined information is recorded on the recording surface of an optical disk in the recording step. Content information representing the content recorded on the optical disk on which the information has been recorded in the recording step is generated in the generating step. A visible image is formed in the forming step on the non-recording surface of the optical disk based on the content information generated in the generating step.

As a result, a visible image that allows the user to visibly recognize the content recorded on the optical disk can be formed on the non-recording surface of the optical disk.

To achieve the above object, a recording medium according to a fourth aspect of the present invention stores a program for controlling a computer to execute a visible image forming method comprising: a recording step of recording predetermined information on a recording surface of an optical disk; a generating step of generating content information representing a content recorded on the optical disk on which the information has been recorded in the recording step; and a forming step of forming a visible image on a non-recording surface of the optical disk based on the content information generated in the generating step.

To achieve the objects, according to the fifth aspect of the invention, there is provided a computer data signal embedded in a carrier wave, representing a program for controlling a computer to execute: a recording step of recording predetermined information on a recording surface of an optical disk; a generating step of generating content information representing a content recorded on the optical disk on which the information has been recorded in the recording step; and a forming step of forming a visible image on a non-recording surface of the optical disk based on the content information generated in the generating step.

### BRIEF DESCRIPTION OF THE DRAWINGS

These objects and other objects and advantages of the present invention will become more apparent upon reading of the following detailed description and the accompanying drawings in which:

FIG. 1 is an exemplary diagram showing one example of the configuration of an optical disk according to the embodiment of the present invention;

FIG. 2 is a block diagram showing one example of the configuration of a recording apparatus;

FIG. 3 is a flowchart for explaining the operation of the recording apparatus; and

FIG. 4 is a diagram for explaining one example of an image formed on an optical disk by the recording apparatus.

### DETAILED DESCRIPTION OF THE PREFERRED EMBODIMENT

A recording apparatus according to an embodiment of the present invention will now be explained with reference to the drawings. The present recording apparatus records predetermined information on the recording surface of an optical disk, and forms a visible image representing the recorded content on the non-recording surface of the optical disk.

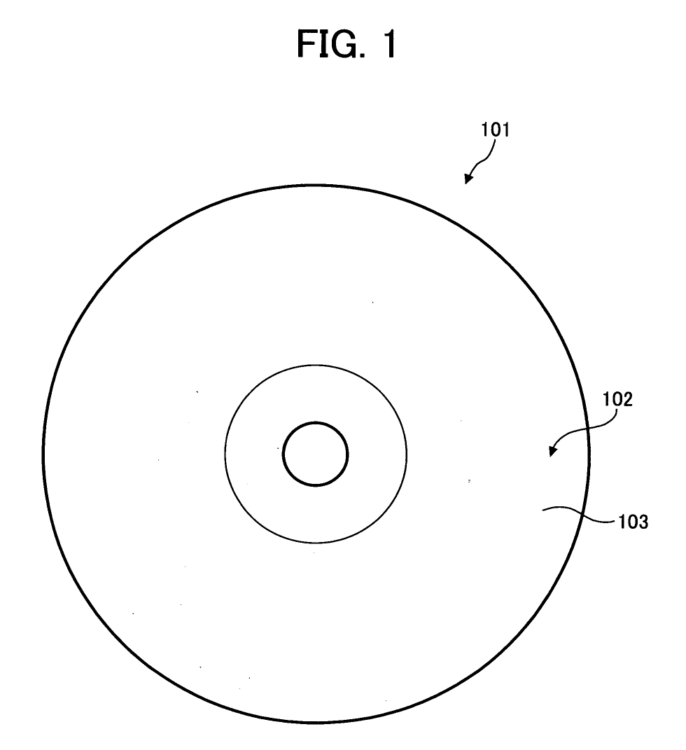

FIG. 1 is a plan view of the non-recording surface side (label surface side) of an optical disk 101 employed in the present embodiment.

The optical disk 101 is constituted by, for example, a writable DVD (DVD−R, DVD+R, DVD-RW, DVD-RW, DVD-RAM, etc.), and has a recording surface on the other side (back surface side) on which a predetermined amount of information can be recorded. The optical disk 101 may be a writable CD (CD-R, CD-RW, etc.).

A thermosensitive medium 103 on which a visible image of characters, images, etc. can be thermally formed is provided on the label surface 102.

The thermosensitive medium 103 may be a type that accepts formation of a visible image only once (direct thermal), or alternatively, a type that accepts rewritable formation of a visible image (thermal rewritable).

In a case where a reversible thermosensitive medium (thermal rewritable) is used as the thermosensitive medium 103, thermal forming/erasing of visible image can be repeated.

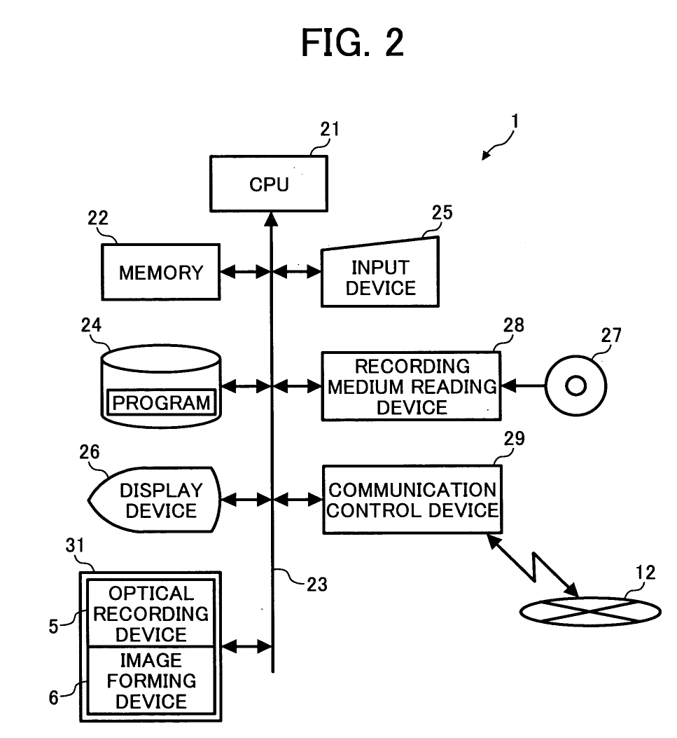

FIG. 2 is a block diagram showing one example of the configuration of a recording apparatus 1. As one example, the recording apparatus 1 is shown as a personal computer equipped with an optical disk drive.

As shown, the recording apparatus 1 comprises a CPU (Central Processing Unit) 21, a memory 22, a magnetic storage device 24, an input device 25, a display device 26, a recording medium reading device 28, a communication control device 29, and an optical disk drive device 31. Each of these (each of these sections) is connected to the others via a bus 23.

The CPU 21 executes various operations and centrally controls each section.

The memory 22 is constituted by a ROM, a RAM, or the like, and stores various information.

The magnetic storage device 24 is constituted by a hard disk or the like, and stores a program 30, etc.

The input device 25 comprises a keyboard, a mouse, etc, and receives input of predetermined instruction information in response to a user's operation.

The display device 26 is constituted by a monitor or the like, and displays an image representing an operational status of the recording apparatus 1, information reproduced by the optical disk drive device 31, etc.

The recording medium reading device 28 reads information stored on a recording medium 27 constituted by a CD or the like. The recording medium reading device 28 may be omitted and the optical disk drive device 31 may read information stored on the recording medium 27.

The communication control device 29 is constituted by a modem, a LAN card, or the like, and controls communication with other apparatuses via a network 12 such as the Internet.

The optical disk drive device 31 comprises an optical recording device 5 and an image forming device 6.

The optical recording device 5 records various information on the recording surface of the optical disk 101.

The image forming device 6 includes, for example, a thermal head, and thermally forms a visible image such as characters, images, etc. on the thermosensitive medium 103 of the optical disk 101.

That is, the optical disk drive device 31 records various information on the recording surface of the optical disk 101 by the optical recording device 5, and forms a visible image on the thermosensitive medium 103 of the optical disk 101 by the image forming device 6.

The recording apparatus 1 having this configuration reads the program 30 stored on, for example, the recording medium 27, and installs the program 30 on the magnetic storage device 24. The program 30 may be downloaded via the network 12 and installed on the magnetic storage device 24.

When the program 30 is installed, the recording apparatus 1 becomes able to execute a recording process, etc. to be described later. That is, by the recording process executed by the recording apparatus 1, the optical disk drive device 31 is controlled to record various information on the recording surface of the optical disk 101 and form a visible image representing the recorded content on the thermosensitive medium 103 of the optical disk 101.

The program 30 may be one that can be run on a specific OS (Operating System).

The optical disk 101 is set on an unillustrated tray with the label surface 102 facing upward and then loaded in the recording apparatus 1. Then, the optical recording device 5 can record a broadcast program on the recording surface from below the optical disk 101. The image forming device 6 can thermally form a visible image on the thermosensitive medium 103 from above the optical disk 101.

The operation of the recording apparatus 1 will now be explained with reference to the drawings. Specifically, a case where predetermined information is to be recorded on the recording surface of the optical disk 101 and a visible image representing the recorded content is to be formed on the thermosensitive medium 103 on the optical disk 101 will be explained.

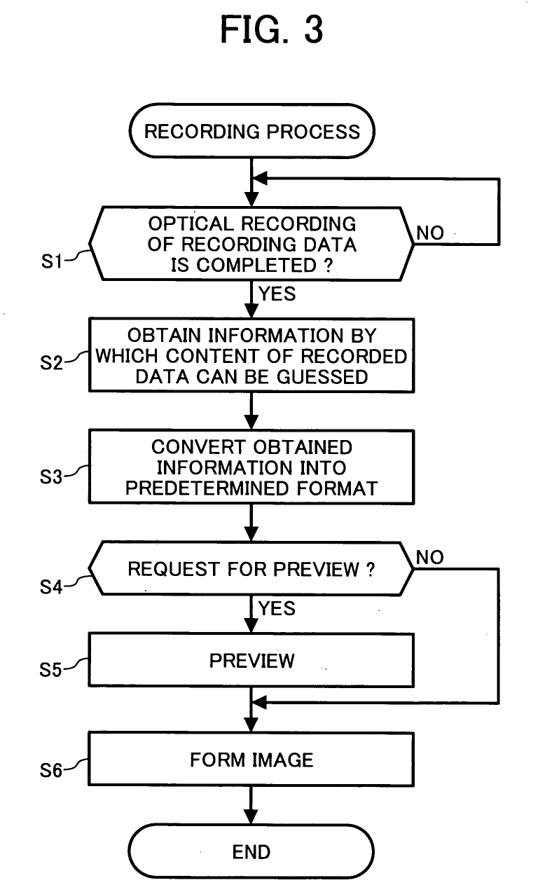

FIG. 3 is a flowchart for explaining the recording process executed by the recording apparatus 1. The recording process is started when a user instructs recording of predetermined information onto the optical disk 101.

First, the recording apparatus 1 executes recording of information onto the optical disk 101 (recording surface), and waits for the recording to be completed (step S1).

When the recording is completed, the recording apparatus 1 obtains information by which the content of the data having been recorded can be guessed, from the recorded data (step S2). That is, the recording apparatus 1 obtains information representing the recorded content.

The recording apparatus 1 converts the obtained information into image data of a predetermined format (step S3). Then, the recording apparatus 1 applies image formation to the thermosensitive medium 103 by the image forming device 6, based on the image data of the predetermined format (step S6). In a case where a request is given from the user before the image formation (step S4; Yes), the recording device 1 displays the image to be formed in the image formation on the display device 26 for preview, based on the image data obtained by the conversion in step S3 (step S5). Because of this, the user can know the image to be formed on the thermosensitive medium 103 beforehand.

There are some times when information is additionally recorded after predetermined information is recorded on the optical disk 101. In such a case, if the thermosensitive medium 103 can allow image formation (printing) by the image forming device 6 only once, the recording apparatus 1 has to determine to where in the thermosensitive medium 103 printing has been applied to in the prior printing, and has to print new information after where the printing has been applied to.

On the other hand, if the thermosensitive medium 103 is rewritable by the image forming device 6, the prior print may be erased and the image for the prior information and the image for the current information may be printed from scratch. Therefore, the determination to where in the thermosensitive medium 103 printing has been applied to in the prior printing is not necessary.

In this case, it is convenient if a file in which information to be printed on the thermosensitive medium 103 is recorded is recorded on the recording surface of the optical disk 101, so that the image for the prior information can be re-printed together with the image for the current information by reading the content information about the prior information that is to be printed on the thermosensitive medium 103 from the file. Note that it is not indispensable to record such a file on the recording surface of the optical disk 101. This is because, since the prior information itself is recorded on the optical disk 101, information necessary to be printed on the thermosensitive medium 103 can be read from this information.

It is preferred that information files to be recorded on the optical disk 101 be standardized among manufacturers of the recording apparatus 1, so that the information in the files can be properly recognized even if the optical disk 101 is loaded in the recording apparatus 1 of different manufacturers.

The thermosensitive medium 103 may be embodied as one that accepts printing only once as described before. In this case, it is considered that printing to the thermosensitive medium 103 is executed when the recording session in which recording is executed on the optical recording surface of a DVD−R or a DVD+R, which is the optical disk 101, is closed. Additional recording of information becomes impossible by closing the session, but the recorded information can be reproduced by a DVD player or the like.

The processes from step S2 will now be explained in detail below.

First, the process (step S2) for obtaining information from which the content of the recorded data can be guessed will be specifically explained. The information to be obtained includes such information as shown below, and this will be the information to be printed (indicated).

Volume Name

For example, data representing the year, the date, and the time when the recording is executed may be read from a clock included in the recording apparatus 1 and used as volume name.

Title

In order to give a title to the content of recorded data, it is considered to guess the content of the recorded data from the extension attached to the file of the recorded data and to use the guessed content as the title. For example, if the extension is “JPG”, the file is a “still image file”, and if the extension is “MPG”, the file is a “moving image file”. In a case where there are a plurality of files, the title is indicated based on the extension that is the largest in number.

File Name, Folder Name

A file name is indicated when there is no folder. When there is a folder, the folder name is indicated instead of a file name. If folders are tiered, the tiered structure of the folders is indicated. In a case where the number of folders is large, it is difficult to indicate all the tiers due to the limited space on the thermosensitive medium 103. Therefore, the depth of the tiers to be indicated is limited as the number of folders becomes larger.

Remaining Data Capacity

The remaining data capacity representing the amount of data still recordable on the optical disk 101 is indicated.

Latest Recording Date

The year and the date when the last recording was executed on the optical disk 101 are indicated.

Next, the process (step S3) for converting the information obtained in step S2 into image data of a predetermined format will be explained. In this process, the data to be indicated is sorted out in the manners described below.

(1) In a case where data of plural subjects are recorded on the optical disk 101, the images are indicated on the thermosensitive medium 103 in the order of data having a newer recording date.

(2) The character size to be used for printing is selected based on the number of characters to be printed, because the range in which image formation can be applied is limited in the thermosensitive medium 103 of the optical disk 101. In other words, a smaller character size is selected as the number of characters to be printed is larger.

(3) Because the range in which image formation can be applied is limited in the-thermosensitive medium 103, a file name or a folder name is indicated up to its character in a predetermined order and characters thereafter are omitted.

(4) The images are indicated on the thermosensitive medium 103 in the order of a folder including a larger number of files or a folder deeper in the tiered structure.

(5) The size of the recording capacity now occupied in the total recordable capacity of the optical disk 101 is indicated in a graphic form. Specifically, it is indicated by a bar chart, a pie chart, etc.

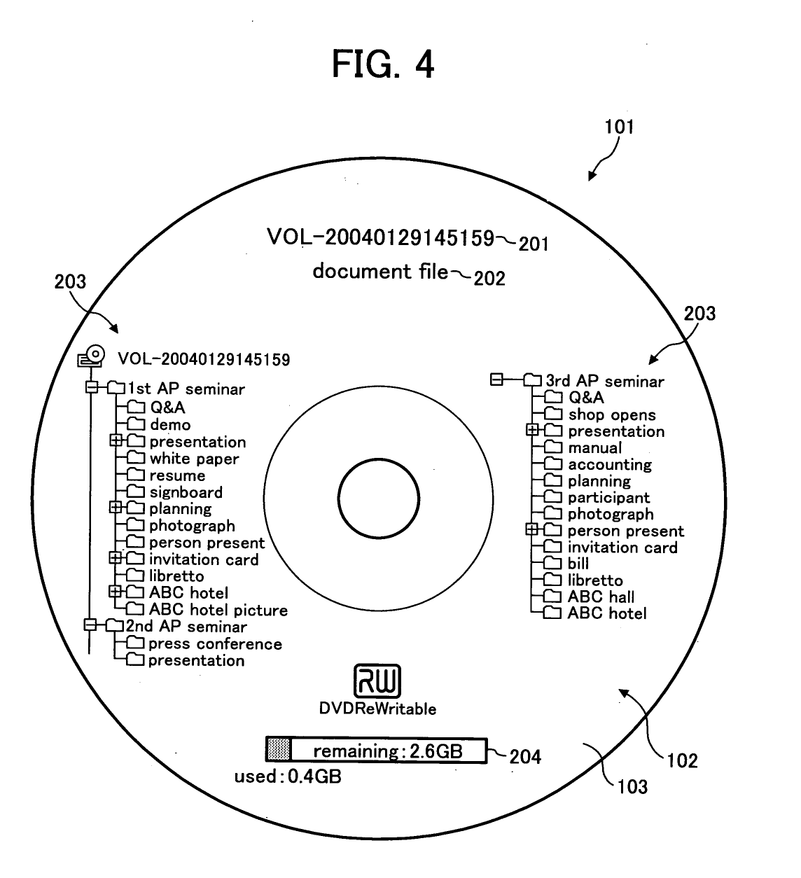

FIG. 4 is an exemplary diagram showing one example of the image on the thermosensitive medium 103 formed by the image forming device 6 in the above-described recording process. In this example, a volume name 201 is printed by the year, the month, the day, the hour, the minute, and the second at which recording is executed, and characters 202 representing “document file” are printed as the title since there are many files having the extension of “doc”. Since the recorded data is structured by two-tiered folders, the folders 203 in this tiered structure are printed. The respective amounts of data capacity used and data capacity remaining are printed by a bar chart 204. The year, the month, and the date 205 when the latest recording is executed are also printed.

As explained above, a visible image that enables the user to visibly recognize the content recorded on the optical disk can be formed on the non-recording surface of the optical disk.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2004-124293 filed on Apr. 20, 2004 and including specification, claims, drawings and summary. The disclosure of the above Japanese Patent Application is incorporated herein by reference in its entirety.

1. A recording apparatus comprising:
a recording section which records predetermined information on a recording surface of an optical disk;
a generation section which generates content information representing a content recorded on the optical disk on which the information has been recorded by said recording section; and
a forming section which forms a visible image on a non-recording surface of the optical disk based on the content information generated by said generation section.

2. The recording apparatus according to claim 1,
wherein said forming section forms the visible image toward a thermosensitive medium provided on the non-recording surface of the optical disk.

3. The recording apparatus according to claim 1,
wherein said forming section forms a new visible image after erasing an already formed visible image, when forming a visible image on a reversible thermosensitive medium provided on the non-recording surface of the optical disk.

4. The recording apparatus according to claim 1,
wherein said generation section generates content information which includes at least any item of a volume name, a folder name, a file name, a remaining data capacity, a used data capacity, and a latest recording date.

5. The recording apparatus according to claim 1,
wherein said generation section generates content information in which folder names and/or file names are arranged in ascending order or in descending order based on recording date and time.

6. The recording apparatus according to claim 1,
wherein said generation section specifies a range in the non-recording surface of the optical disk in which a visible image can be formed, and generates content information in which a size of characters is set such that the characters can be contained within the specified range.

7. The recording apparatus according to claim 1,
wherein said generation section specifies a range in the non-recording surface of the optical disk in which a visible image can be formed, and generates content information in which number of characters is limited such that the characters can be contained within the specified range.

8. The recording apparatus according to claim 1,
wherein said generation section selects a title based on a kind of a file, and generates content information including the selected title.

9. The recording apparatus according to claim 8,
wherein said generation section counts numbers of files of respective kinds, and selects a title corresponding to the kind of files that exist most.

10. The recording apparatus according to claim 1,
wherein said generation section specifies a tiered structure of folders and fifes, and generates content information including an image representing the specified tiered structure.

11. The recording apparatus according to claim 10,
wherein said generation section specifies a range in the non-recording surface of the optical disk in which a visible image can be formed, and generates an image in which number of tiers to be spread open in the tiered structure is limited to a number containable in the specified range.

12. The recording apparatus according to claim 10,
wherein said generation section specifies a tiered structure in which folders are arranged in ascending order or in descending order, based on number of subordinate files and/or number of tiers of subordinate folders.

13. The recording apparatus according to claim 1,
wherein said generation section generates content information including an image representing a relationship between a used data capacity and a remaining data capacity.

14. The recording apparatus according to claim 1, further comprising a display section which displays content information generated by said generation section before said forming section forms a visible image.

15. A recording apparatus comprising:
recording means for recording predetermined information on a recording surface of an optical disk;
generating means for generating content information representing a content recorded on the optical disk on which the information has been recorded by said recording means; and
forming means for forming a visible image on a non-recording surface of the optical disk based on the content information generated by said generating means.

16. A visible image forming method comprising:
a recording step of recording predetermined information on a recording surface of an optical disk;
a generating step of generating content information representing a content recorded on the optical disk on which the information has been recorded in said recording step; and
a forming step of forming a visible image on a non-recording surface of the optical disk based on the content information generated in said generating step.

17. A computer-readable recording medium storing a program for controlling a computer to execute a visible image forming method comprising:
a recording step of recording predetermined information on a recording surface of an optical disk;
a generating step of generating content information representing a content recorded on the optical disk on which the information has been recorded in said recording step; and
a forming step of forming a visible image on a non-recording surface of the optical disk based on the content information generated in said generating step.

18. A computer data signal embedded in a carrier wave, representing a program for controlling a computer to execute:
a recording step of recording predetermined information on a recording surface of an optical disk;
a generating step of generating content information representing a content recorded on the optical disk on which the information has been recorded in said recording step; and
a forming step of forming a visible image on a non-recording surface of the optical disk based on the content information generated in said generating step.
